(19) United States
(12) Patent Application Publication
(10) Pub. No.: US 2007/0118752 A1
(43) Pub. Date: May 24, 2007

(54) Authentication of control units in a vehicle

(75) Inventors: Horst Kiessling, Freising (DE); Burkhard Kuhls, Stadtbergen (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 11/588,235

(22) Filed: Oct. 27, 2006

Related U.S. Application Data
(63) Continuation of application No. PCT/EP04/04666, filed on Apr. 29, 2004.

(51) Int. Cl. H04L 9/00

(52) U.S. Cl. 713/176; 713/181; 713/180; 713/156

(57) ABSTRACT

A control unit transmits an authentication request to an authentication device via the bus system. The authentication device signs the authentication request using a first symmetric key and transmits the signed authentication request or only the signature to the control unit. The control unit compares the transmitted signature of the authentication request with a signature, which is determined by the control unit by applying the symmetric key to the authentication request, and/or the control unit decodes the transmitted signature of the authentication request using the first symmetric key to obtain a first hash value; and the control unit applies a hash algorithm to the authentication request to obtain a second hash value. The control unit is rendered operational if the comparison of the signatures and/or the hash values is positive or if the signatures and/or the hash values match.

### CROSS REFERENCE TO RELATED APPLICATIONS

This application is a continuation of PCT International Application No. PCT/EP2004/004666, filed Apr. 29, 2004, the entire disclosure of which is herein expressly incorporated by reference. This application is related to PCT International Application No. PCT/EP2004/004665, filed Apr. 29, 2004, and U.S. patent application Ser. No. ______ (Atty. Docket No. 080437.58342US) entitled “Authentication of a Vehicle-External Device,” which is filed on even date herewith. The entire contents of the related applications is herein expressly incorporated by reference.

### BACKGROUND AND SUMMARY OF THE INVENTION

The present invention relates to a method for authenticating control units in a bus system of a vehicle.

In order to prevent the sequence control system, which is stored in control units, or the corresponding software, which is executed by one or more of the processors, provided in the control units, from being manipulated, it is important to monitor the authorization of the access to the control units. The authorization may be verified by cryptographic measures. Execution of the corresponding cryptographic measures stresses the processor(s) of the control unit and other hardware components of the control unit or requires more powerful and, thus, more expensive control units. The more powerful control units may be required in a control unit that is used millions of times, as in the case of the control unit of a motor vehicle.

Exemplary embodiments of the present invention provide a method that effectively and inexpensively prevents a sequence control system, which is stored in a control unit, from being manipulated.

Other objects, advantages and novel features of the present invention will become apparent from the following detailed description of the invention when considered in conjunction with the accompanying drawings.

### BRIEF DESCRIPTION OF THE DRAWING FIGURES

FIG. 1 illustrates an exemplary system in accordance with the present invention; and

FIG. 2 illustrates an exemplary method in accordance with one embodiment of the present invention.

### DETAILED DESCRIPTION OF THE DRAWINGS

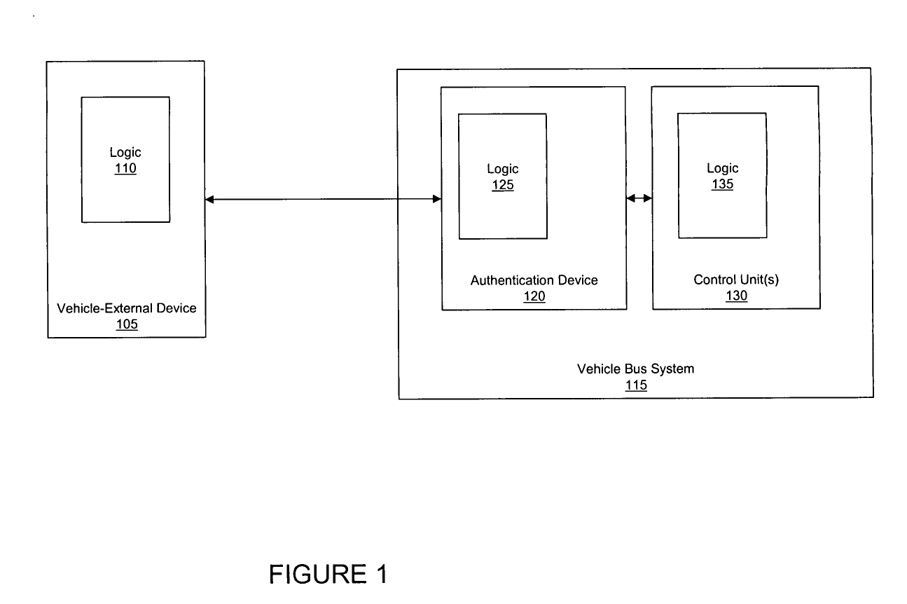

FIG. 1 illustrates an exemplary system in accordance with the present invention. The system includes vehicle-external device 105 and a vehicle bus system 115. Vehicle bus system 115 includes authentication device 120 and control unit(s) 130. Vehicle-external device 105 includes logic for performing acts described below, authentication device 120 includes logic for performing acts described below, and control unit(s) 130 includes logic for performing acts described below. This logic can be a processor that executes code loaded from a computer readable medium, an application specific integrated circuit (ASIC), field programmable gate array (FPGA), and/or the like.

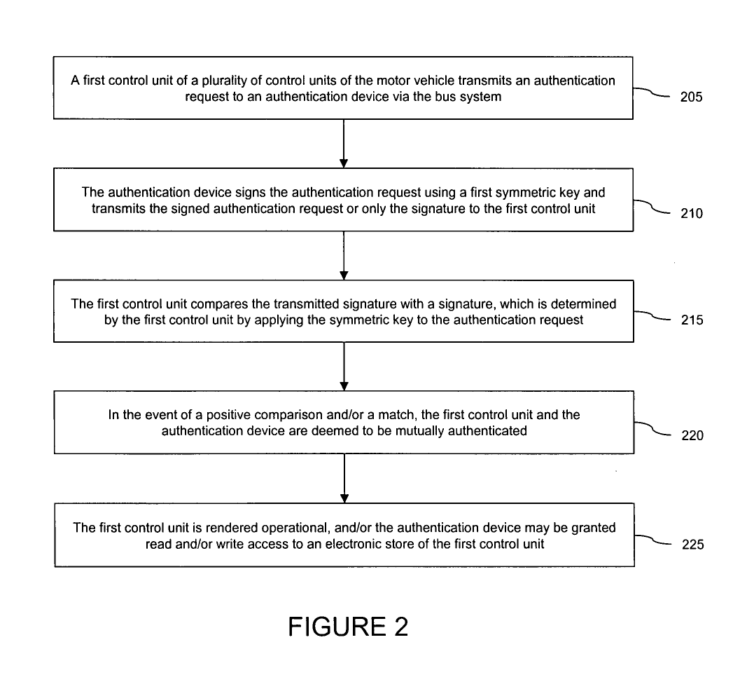

Exemplary embodiments of the present invention provide for authenticating control units or for testing whether it involves authorized control units in the bus system consists of the execution of the following measures. Referring to FIG. 2, a first control unit of a plurality of control units of the motor vehicle transmits an authentication request to an authentication device via the bus system (step 205). The authentication request can be a random number or the like, which is generated by the control unit and which is generated only once. The authentication device can be a central control unit, which has access to a symmetric, cryptographic key and may carry out a symmetric cryptographic method.

The execution of a symmetric cryptographic method avails itself to the resources, in particular the processor, the control unit and/or the authentication device considerably less than an asymmetric method so that in applying the invention, the control units may be constructed at a significantly more reasonable cost.

The authentication device signs the authentication request using a first symmetric key and transmits the signed authentication request or only the signature to the first control unit (step 210). The signing or the creation of the signature occurs by applying a hash algorithm to the authentication request or rather the authentication data. The hash algorithm gives a hash value, which is characteristic of the specific authentication data. The hash value is encoded with the first symmetric key; and the encoded hash value is attached to the authentication request or to the authentication data and transmitted together with the authentication request to the first control unit. As an alternative, only the signature and/or the encoded hash value may also be transmitted to the first control unit, because the authentication request was created, of course, in said first control unit and, therefore, already exists.

The first control unit compares the transmitted signature with a signature that is determined by the first control unit by applying the symmetric key to the authentication request (step 215). The signature may be determined by the first control unit in that the same hash algorithm, which was applied by the authentication device to the authentication request for determining the signature, is also applied by the first control unit to the authentication request. The result in turn is a hash value. This hash value or the signature, which is created on the basis of the hash value using the symmetric key, is compared in turn with the transmitted signature or the hash value, which is obtained from the transmitted signature in turn using the symmetric key.

In the event of a positive comparison and/or a match, the first control unit and the authentication device are deemed to be mutually authenticated (step 220). That is, for the control unit the authentication device is deemed to be genuine or rather authorized and vice versa. Accordingly, in the event of a positive comparison and/or a match, the first control unit is rendered operational. As an alternative or in addition, the authentication device may be granted read and/or write access to an electronic store of the first control unit.

In accordance with one embodiment of the present invention, one or more of the other control units of the bus system carries out or carry out in the described manner an authentication method with the authentication device. Using these measures, one may also check whether there are unauthorized control units or an unauthorized authentication device in the bus system.

In another exemplary embodiment of the present invention the authentication of the control units with respect to the authentication device is carried out one after the other. This reduces the necessary hardware resources.

One exemplary embodiment of the present invention provides that the motor vehicle may be started up only after all of the control units of the bus system have executed the method for authenticating with positive results from the comparison. In this way the working reliability of the bus system and/or the compatibility of the bus participants may be guaranteed. Similarly this measure increases the anti-theft protection of the motor vehicle that is equipped with the bus system of the invention, when an engine immobilizer system is integrated into the bus system and/or into the control units.

Another exemplary embodiment of the present invention provides that the execution of the authentication method is carried out prior to starting the vehicle, such as after opening the vehicle. With this method one can check periodically the working reliability, compatibility, etc.

In one exemplary embodiment of the present invention, prior to starting the vehicle, the inventive authentication method is carried out only for those control units that have to be available when starting the vehicle, in order to render the vehicle operational—if desired—with a short lead time. Then after the start procedure of the vehicle, the inventive authentication method may be carried out for the other control units, without impeding the startup process of the motor vehicle.

Another exemplary embodiment of the present invention provides that all control units largely use the same symmetric key in carrying out the authentication method. This measure makes the key management simple and has the additional advantage that the control units of the vehicle concerned are assigned in this way to each other.

One exemplary embodiment of the present invention provides that the symmetric key varies from vehicle to vehicle; and in carrying out the inventive authentication method, a control unit of a first vehicle accesses a first symmetric key; and in carrying out the method, the same control unit of a second vehicle accesses a second symmetric key.

The symmetric key is preferably “housed” in the bus system in such a manner that it may be read (that is, remains secret and may not be altered in an unauthorized manner) only by the authentication device and by the control units, involved in the method. In one aspect of the present invention, the symmetric key is stored in the non-externally readable or alterable boot area of each control unit and in the corresponding area of the authentication device.

Since the symmetric key varies from vehicle to vehicle, spying out the symmetric key of a specific vehicle is comparatively harmless. Of course, the situation would be totally different, if a symmetric key of a vehicle that “fits” all vehicles of the same model were spied out.

One exemplary embodiment of the present invention provides that the inventive method runs in the reverse direction. That is, the authentication device transmits an authentication request to the first control unit; the first control unit signs the authentication request with the first symmetric key and transmits the signed authentication request to the authentication device. In so doing, the comparison is shifted from the control unit to the authentication device. This is done by relieving each control unit of its resources and loading the authentication device with the resources. The repeated shedding of resources, as compared to a single loading of resources, results in a reduction in the cost of hardware.

One exemplary embodiment of the present invention provides that the authentication device carries out another authentication test by carrying out an asymmetric encoding method with a vehicle-external device, in particular a public key method.

One exemplary embodiment of the present invention provides that the authentication device transmits an authentication request or the authentication data to the vehicle-external device. The vehicle-external device applies a hash algorithm to the authentication request or to the authentication data, whereby a hash value is obtained. The hash value is encoded with a secret personal key; and the encoded hash value is attached to the authentication request or rather the authentication data. That is, the authentication request is signed, and the signed authentication request or only the signature (that is, the hash value, encoded with the secret key) is transmitted to the authentication device.

The authentication device also applies the hash algorithm to the authentication request, and the result is a second hash value. Furthermore, the authentication device decodes the encoded hash value, obtained from the vehicle-external device, with the public key, which is complementary to the personal, secret key, and compares the first hash value with the second hash value. If the comparison is positive (that is, if the two hash values match), then the vehicle-external device has successfully authenticated itself with respect to the authentication device in the vehicle. On this basis the vehicle-external device may be granted write and/or read access to one or more of the stores of one or more of the control units by controlling the authentication device.

One exemplary embodiment of the present invention enables the vehicle-external device to provide the store of one or more of the control units with a new sequence control system or rather software and/or with an activation code. The new sequence control system may be in particular a sequence control system that has been updated with respect to the previous sequence control system, that eliminates software problems, and/or renders operational additional functions of the control unit. The new sequence control system may be an addition to the sequence control system, which is already stored in the control unit and which renders operational in particular additional functions of the control unit.

The activation code may be data, said activation code activating—especially limited by time—a sequence control system or rather the software that is kept operational to run in the control unit or at another location in the vehicle. That is, the sequence control system or the software that is already stored in the vehicle may not be carried out until after the activation code has been made operational in the vehicle.

The invention makes possible a bus system of a motor vehicle with control units. The bus system has an authentication device; and a method, according to the invention, is carried out in the bus system. Furthermore, the invention makes possible a computer program product for authentication of the control units in a bus system of a motor vehicle; said computer program product allows a method, according to one or more of the following method claims, to run.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for authenticating control units in a bus system of a motor vehicle, the method comprising the acts of:
transmitting, by a first control unit, an authentication request to an authentication device via the bus system,
signing, by the authentication device, the authentication request using a first symmetric key and transmitting the signed authentication request or only the signature to the first control unit,
wherein
the first control unit compares the transmitted signature of the authentication request with a signature, which is determined by the first control unit by applying the symmetric key to the authentication request, or
the first control unit decodes the transmitted signature of the authentication request using the first symmetric key, and a first hash value is obtained; and the first control unit applies a hash algorithm to the authentication request, whereby a second hash value is obtained, and
wherein the first control unit is rendered operational if the comparison of the signatures and/or the hash values is positive or if the signatures and/or the hash values match.

2. The method of claim 1, wherein one or more of the other control units of the bus system carry out or carries out the method for authentication.

3. The method of claim 1, wherein the motor vehicle may be started up only after all control units of the bus system have executed the method for authentication with positive results from the comparison.

4. The method of claim 1, wherein the execution of the authentication method is carried out prior to starting the vehicle.

5. The method of claim 1, wherein all control units use the same symmetric key in carrying out the authentication method.

6. The method of claim 1, wherein the symmetric key varies from vehicle to vehicle, and in carrying out the authentication method a control unit of a first vehicle accesses a first symmetric key and the same control unit of a second vehicle accesses a second symmetric key.

7. A method for authenticating control units in a bus system of a motor vehicle, the method comprising the acts of:
transmitting, by an authentication device, an authentication request to a first control unit via the bus system,
signing, by the first control unit, the authentication request using a first symmetric key and transmitting the signed authentication request or only the signature to the authentication device,
wherein
the authentication device compares the transmitted signature of the authentication request with a signature, which is determined by the authentication device by applying the symmetric key to the authentication request, or
the authentication device decodes the transmitted signature of the authentication request using the first symmetric key, and a first hash value is obtained; and the authentication device applies a hash algorithm to the authentication request, whereby a second hash value is obtained, and
wherein the first control unit is rendered operational if the comparison of the signatures and/or the hash values is positive or if the signatures and/or the hash values match.

8. The method of claim 7, wherein the authentication device carries out another authentication test by carrying out an asymmetric encoding method with a vehicle-external device.

9. The method of claim 8, further comprising the acts of:
transmitting, by the authentication device, an authentication request to the vehicle-external device;
signing, by the vehicle-external device, the authentication request with a secret key of an asymmetric pair of keys, and transmitting the signed authentication request or exclusively the signature to the authentication device; and
determining, by the authentication device, a signature of the authentication request using the same algorithm as the vehicle-external device, decoding the signature transmitted by the vehicle-external device, using the public key, which is complementary to the secret key, and comparing the determined signature with the transmitted signature.

10. The method of claim 9, wherein if the comparison is positive, the vehicle-external device obtains write and/or read access to a store of the first control unit by way of the authentication device.

11. A bus system of a motor vehicle, the bus system comprising:
control units; and
an authentication device, wherein
a first control unit of the control units transmits an authentication request to the authentication device via the bus system,
the authentication device signs the authentication request using a first symmetric key and transmitting the signed authentication request or only the signature to the first control unit,
wherein
the first control unit compares the transmitted signature of the authentication request with a signature, which is determined by the first control unit by applying the symmetric key to the authentication request, or
the first control unit decodes the transmitted signature of the authentication request using the first symmetric key, and a first hash value is obtained; and the first control unit applies a hash algorithm to the authentication request, whereby a second hash value is obtained, and
wherein the first control unit is rendered operational if the comparison of the signatures and/or the hash values is positive or if the signatures and/or the hash values match.

12. A bus system of a motor vehicle, the bus system comprising:
control units; and
an authentication device,
wherein the authentication device and a first one of the control units includes computer program products for performing the acts of
transmitting, by a first control unit, an authentication request to an authentication device via the bus system,
signing, by the authentication device, the authentication request using a first symmetric key and transmitting the signed authentication request or only the signature to the first control unit,
wherein
the first control unit compares the transmitted signature of the authentication request with a signature, which is determined by the first control unit by applying the symmetric key to the authentication request, or
the first control unit decodes the transmitted signature of the authentication request using the first symmetric key, and a first hash value is obtained; and the first control unit applies a hash algorithm to the authentication request, whereby a second hash value is obtained, and
wherein the first control unit is rendered operational if the comparison of the signatures and/or the hash values is positive or if the signatures and/or the hash values match.
